(19) United States
(12) Patent Application Publication
(10) Pub. No.: US 2026/0081447 A1
(43) Pub. Date: Mar. 19, 2026

(54) EXTERNAL POWER SYSTEMS FOR OUTDOOR SECURITY SYSTEMS

(71) Applicant: SkyBell Technologies IP, LLC, Irvine, CA (US)

(72) Inventors: Gregory S. Davi, Tracy, CA (US); Joseph Frank Scalisi, Yorba Linda, CA (US)

(21) Appl. No.: 19/106,959

(22) PCT Filed: Aug. 22, 2023
(86) PCT No.: PCT/US2023/030835

§ 371 Date: Feb. 26, 2025

Related U.S. Application Data
(60) Provisional application No. 63/403,280, filed on Sep. 1, 2022.

(51) Int. Cl. H02J 7/00; G08B 25/10; H01M 10/46; H01M 50/24; H01M 50/251; H02J 7/35

(52) U.S. Cl. CPC H02J 7/855; H01M 10/465; H01M 50/24; H01M 50/251; G08B 25/10; H01M 2220/10; H02J 7/35

(57) ABSTRACT

An outdoor comfort-and-security system may include at least one electronic, device configured to be positioned around an exterior premise of a. building. In some examples, each electronic device comprises communication circuitry configured to communicate data via a wireless network. According to some examples, the outdoor comfort-and-security system includes a battery configured to be positioned exteriorly from the building. The battery may be physically distinct from the at least one electronic device and electrically coupled to the at least one electronic device. In some examples, the battery comprises a. minimum power output configured to power a respective primary function of the at least one electronic device and to enable the communication circuitry of the at least one electronic device to communicate the data via the wireless network.

### CROSS-REFERENCE TO RELATED APPLICATIONS

The present application claims priority to U.S. Provisional Patent Application No. 63/403,280 filed on Sep. 1, 2022, entitled “EXTERNAL POWER SYSTEMS FOR OUTDOOR SECURITY SYSTEMS” the entire disclosure of which is incorporated by reference herein.

### BACKGROUND OF THE INVENTION

The present disclosure relates to systems and methods of providing power from an external power supply to outdoor devices.

Current systems of outdoor devices that rely on electricity generally use one of two potential sources of power. Some outdoor electronic devices contain integral power supplies, which inhibit the potential size of the power supply by forcing the power supply to fit within the housing of the electronic device. Other outdoor electronic devices wire to a remote transformer, which are generally large and unsightly. Thus, there is a need for systems and methods to remedy these deficiencies found in the prior art.

### SUMMARY OF THE INVENTION

The disclosure includes an outdoor comfort-and-security system. In some examples, the system includes at least one electronic device configured to be positioned around an exterior premise of a building, each electronic device comprising communication circuitry configured to communicate data via a wireless network. According to some examples, the system includes a battery configured to be positioned exteriorly from the building. The battery may be physically distinct from the at least one electronic device and electrically coupled to the at least one electronic device. In some examples, the battery comprises a minimum power output configured to power a respective primary function of the at least one electronic device and to enable the communication circuitry of the at least one electronic device to communicate the data via the wireless network.

According to some examples, the system further comprises a solar panel configured to be positioned exteriorly from the building, wherein the solar panel is electrically coupled to the battery to provide auxiliary power to the battery during a daylight time. The battery may further comprise a housing comprising at least two nested waterproof layers. In some examples, the housing further comprises a di-electrical gel membrane positioned between the at least two nested waterproof layers.

According to some examples, the system further comprises a concealment device defining a cavity configured to receive the battery. An exterior surface of the concealment device may be configured to represent an object selected from the group consisting of a landscaping rock, a brick, a planting pot, and combinations thereof.

In some examples, the at least one electronic device comprise at least one security camera. According to some examples, the at least one electronic device comprises at least one motion detector. The at least one electronic device may comprise at least one outdoor light. In some examples, the communication circuitry of the at least one electronic device is configured to wirelessly communicate the data on a local network associated with the building. The data may include still images or video from cameras, distance information from location ranging, heat signature information from IR detectors, vibration information from vibration sensors, air information from air sensors, sound information from audio detectors, and radio transmissions from radio transmitters. According to some examples, the communication circuitry of the at least one electronic device is configured to wirelessly communicate the data to a remote computing device via a cellular network.

The disclosure also includes a battery configured to power at least one electronic device of an outdoor comfort-and-security system of a building. In some examples, the battery is configured to be positioned exteriorly from the building. According to some examples, the battery is physically distinct from the at least one electronic device and configured to removably and electrically couple to the at least one electronic device. The battery may comprise a minimum power output configured to power a respective primary function of the at least one electronic device and to enable communication circuitry of the at least one electronic device to communicate data via a wireless network.

In some examples, the battery further comprises an electronic interface configured to electrically couple to a solar panel configured to be positioned exteriorly from the building and configured to provide auxiliary power to the battery during a daylight time. According to some examples, the battery further comprises a housing comprising at least two nested waterproof layers. The housing may further comprise a di-electrical gel membrane positioned between the at least two nested waterproof layers. In some examples, an exterior surface of the battery is configured to represent an object selected from the group consisting of a landscaping rock, a brick, a planting pot, and combinations thereof.

The disclosure also includes a first electronic device for an outdoor comfort-and-security system, wherein the first electronic device is configured to be positioned at an exterior premise of a building. In some examples, the first electronic device includes communication circuitry configured to communicate data via a wireless network. According to some examples, the first electronic device includes an electronic coupling. The electronic coupling may include a first interface configured to removably and electrically couple the first electronic device to a battery configured to be positioned exteriorly from the building and having a minimum power output configured to power a primary function of the first electronic device and to enable the communication circuitry of the first electronic device to communicate the data via the wireless network. In some examples, the electronic coupling includes a second interface configured to electrically couple to the first interface and configured to removably and electrically couple to a second electronic device of the outdoor comfort-and-security system.

According to some examples, the first electronic device is selected from the group consisting of a security camera, a motion detector, an outdoor light, and combinations thereof.

The first electronic device may further comprise a battery configured to be positioned exteriorly from the building. In some examples, the battery is physically distinct from the first electronic device and the second electronic device. According to some examples, the battery comprises a minimum power output configured to power a respective primary function of at least one of the first electronic device and the second electronic device, and to enable the communication circuitry of at least one of the first electronic device and the second electronic device to communicate the data via the wireless network.

The first electronic device may further comprise a solar panel configured to be positioned exteriorly from the building, wherein the solar panel is electrically coupled to the battery to provide auxiliary power to the battery during a daylight time.

The foregoing, and other features and advantages of the invention, will be apparent from the following, more particular description of the preferred embodiments of the invention, the accompanying drawings, and the claims.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a schematic view of an outdoor system including at least one electronic device and a battery, according to some embodiments.

FIG. 2 illustrates a schematic view of the outdoor system of FIG. 1 including a solar panel coupled to the battery, according to some embodiments.

FIG. 3 illustrates a schematic view of the outdoor system of FIG. 1 including a security camera, a motion detector, and an outdoor light, according to some embodiments.

FIG. 4B illustrates the front view of the battery housing of FIG. 4A, according to some embodiments.

FIG. 5 illustrates a schematic view of an outdoor system including a concealment device, according to some embodiments.

FIG. 6A illustrates a front view of a possible concealment device, according to some embodiments.

FIG. 6B illustrates a front view of an additional example of a possible concealment device, according to some embodiments.

FIG. 6C illustrates a front view of another additional example of a possible concealment device, according to some embodiments.

FIG. 7 illustrates a flowchart depicting a method of providing power to an outdoor device, according to some embodiments.

FIG. 8 illustrates a flowchart depicting a method of providing auxiliary power to a battery, according to some embodiments.

FIG. 9 illustrates a flowchart depicting a method of concealing a battery, according to some embodiments.

FIG. 10 illustrates a flowchart depicting a method of transmitting data from outdoor devices, according to some embodiments.

### COMPONENT INDEX

10—Building
20—Exterior premise
30—Outdoor comfort-and-security system
102—Battery
104—At least one electronic device
106—Wire
106a—Output wire
106b—Input wire
202—Solar panel
302—Outdoor light
304—Motion detector
306—Security camera
402—Housing
404—Waterproof layer
406—Vacuum
408—Di-electrical gel membrane
410—Door
502a—Concealment device
502b—Concealment device
502c—Concealment device
602—Arrow

### DETAILED DESCRIPTION OF THE INVENTION

Most residential yard landscaping or security devices are either dependent on external power from a transformer, or small, internal batteries that are insufficient to power the device for very long. It is much more practical and desirable to use a dedicated battery for these electronics rather than receiving power from a transformer, so these devices with internal batteries see greater use. However, this means that, because the batteries are stored internal to the device, the housing size of the device limits the potential size of the battery. The physical size and capacity of the battery may limit the lifespan of the device and prevents the device from performing more complex operations For instance, a yard landscaping device may be an LED lighting fixture that only turns on from sunset to midnight, automatically turning itself off to avoid battery damage and permitting the battery to recharge during the day, perhaps through a solar cell. Such an LED lighting fixture would lack further capabilities, such as communication to a remote computing device where a user could manually control whether or not the light is turned on, change the lighting schedule, etc.

In systems where the electronic devices wire directly to a transformer, the transformer remains a visible component of the system-transformers are large and unsightly, and may ruin the aesthetic of a landscape. Because of the size of transformers, it is difficult to disguise them as something more aesthetically pleasing that fit their environment. Additionally, current transformers cannot be removed from the environment simply through burying, as current transformer housings are not suited for weatherproofing or underground storage.

By creating a system of powering these yard landscaping devices (henceforth referred to as “electronic devices” or “at least one electronic devices”) with a dedicated external, remote battery, these problems may be avoided. By making a larger supply of energy available, multiple electronic devices may be powered from a single battery, and the battery may be easily disguised as a component of the yard, whereas, currently a transformer is virtually impossible to disguise.

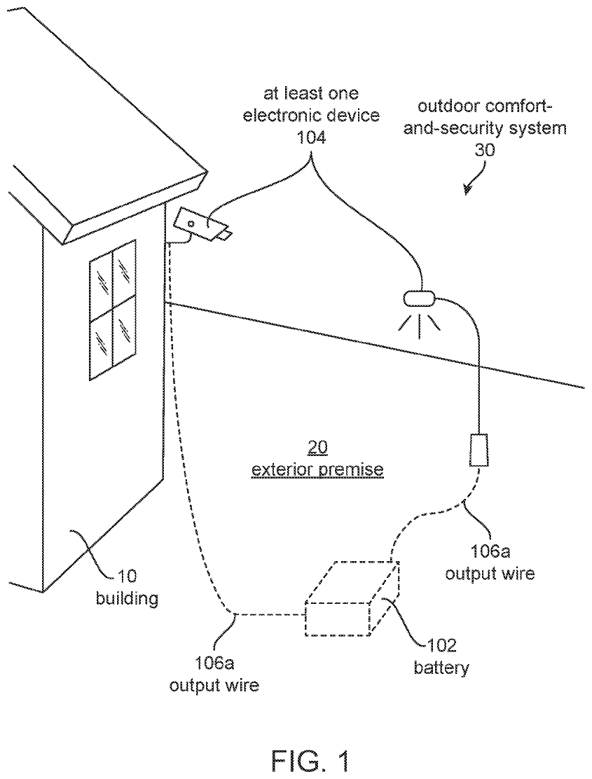

FIG. 1 illustrates a schematic view of an outdoor system 30 including at least one electronic device 104 and a battery 102. In the example of FIG. 1, a battery 102 can be seen as hidden lines underground in the external premise 20 of the building 10, remote from the building 10. The battery 102 can also be seen as remote from the electronic devices 104 throughout the external premise 20 and along the wall of the building 10. This separation of the battery 102 from the electronic devices 104 permits a larger size battery 102, which may support the energy capacity requirements for future electronic devices 104 to be added, such as those which may constitute components of a larger security system 30. Also displayed as hidden lines are output wires 106a. These output wires 106a permit the electrical coupling of the remote battery 102 to each of the at least one electronic devices 104.

Electronic devices 104 that have internal batteries need to have their batteries replaced frequently, as their small size prevents large energy draws for longer periods of time. This also causes these devices to be more simplistic in nature, as they do not provide enough power for advanced capabilities. By providing a battery 102 that outputs a greater amount of power, electronic devices 104 with these greater capabilities may be supported. These capabilities include but are not limited to cameras, location ranging, IR detectors, vibration sensors, air sensors, audio detectors, and radio transmitters.

The battery 102 is independent of the battery technology utilized. For example, lithium ion, nickel cadmium, aluminum, rechargeable batteries, non-rechargeable batteries, etc. may all be utilized. The battery 102 is also independent of the wired interface technology utilized and can be made to connect with, and be compliant with all current and future NSI-UL Standard 1838—Low Voltage Landscape Lighting Systems.

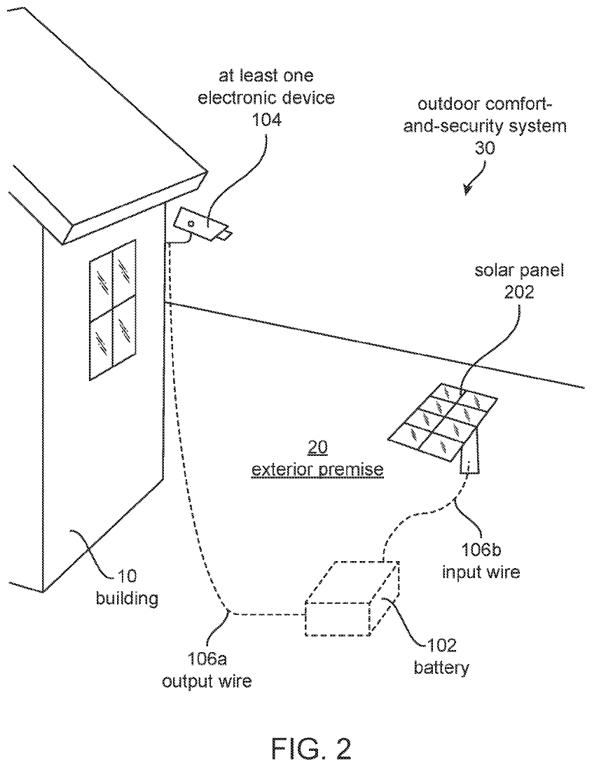

FIG. 2 illustrates a schematic view of the outdoor system of FIG. 1 including a solar panel 202 coupled to the battery 102. By including a remote solar panel, auxiliary power can be provided to the battery 102. The solar panel 202 may be able to directly power the electronic devices 104, as well as refill the energy reserves of the battery 102 during daylight times. As can be seen by hidden lines, an output wire 106a may electrically couple the remote battery 102 to at least one electronic device 104, while an input wire 106b may electrically couple the remote battery 102 to a solar panel 202 for recharging the battery 102.

A large variety of electronic devices 104 may be desirable as a part of the system 30. By including a more powerful battery 102 in the system 30, these electronic devices 104 may be able to include communication circuitry, in order to communicate data with each other present electronic device 104 or with a wireless network. In this manner, it may be possible for the electronic devices 104 to communicate information with a remote computing device of a user through the use of a cellular network. These electronic devices 104 may also be capable of wirelessly communicating the data on a local network associated with the building. For example, the data may include still images or video from cameras, distance information from location ranging, heat signature information from IR detectors, vibration information from vibration sensors, air information from air sensors, sound information from audio detectors, radio transmissions from radio transmitters, or motion information from a motion detector.

In the case of the electronic devices 104 communicating with one another, each electronic device 104 may include an electronic coupling in addition to the communication circuitry. The electronic coupling may include an interface which is configured to removably and electrically couple the electronic device 104 to the battery 102. The battery 102, because it is external to the electronic device 104 and thus not inhibited by the space allotted within the electronic device 104, will have a sufficient minimum power output to power a primary function of the electronic device which enables the communication circuitry of the electronic device to communicate said data via the wireless network.

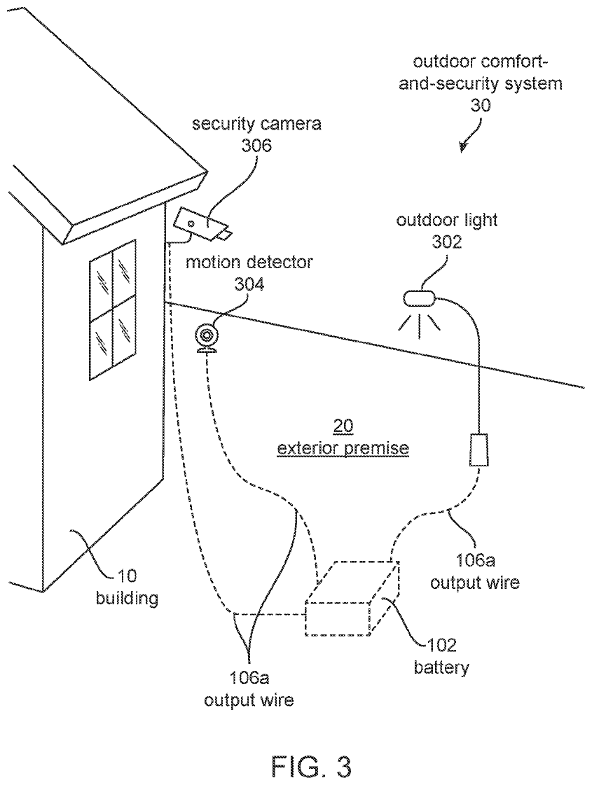

FIG. 3 illustrates a schematic view of the outdoor system of FIG. 1 emphasizing the variety of electronic devices 104 that may be included in the full outdoor system. Shown in FIG. 3 are an outdoor light 302, a motion detector 304, and a security camera 306. However, it is understood that the electronic devices 104 are not limited to an outdoor light 302, a motion detector 304, and a security camera 306, and any other desired electronic device 104 may be included in the system. While not shown in the drawing, motion detector 304 may be coupled to security camera 306. In this configuration, the motion detector may or may not be directly coupled to battery 102. Hidden lines show output wires 106a electrically coupling the remote battery 102 to each of the at least one electronic devices 104, the outdoor light 302, the motion detector 304, and the security camera 306.

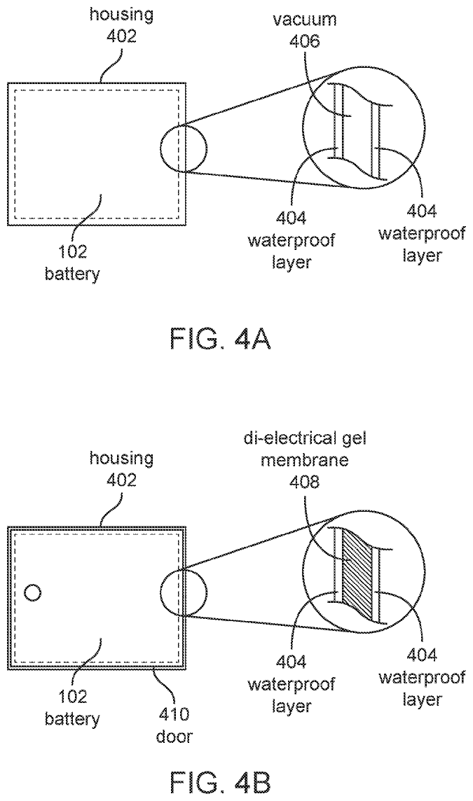

FIGS. 4A and 4B illustrate front views of a battery 102 housing 402 with two similar constructions for weatherproofing the housing 402 of the battery 102. FIG. 4A shows a battery 102 with a housing 402 including two waterproof layers 404 separated by a vacuum 406. FIG. 4B shows a battery 102 with a housing 402 including two waterproof layers 404 with the space between filled with a di-electrical gel membrane 408.

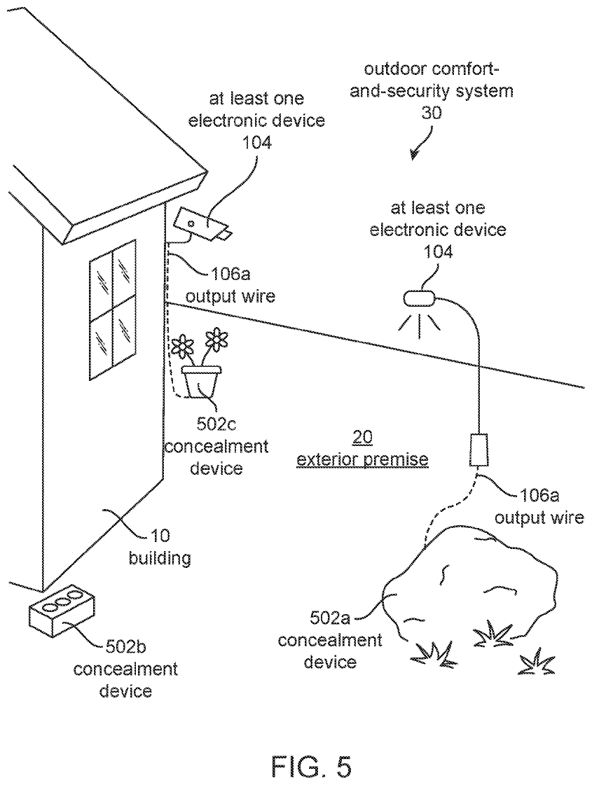

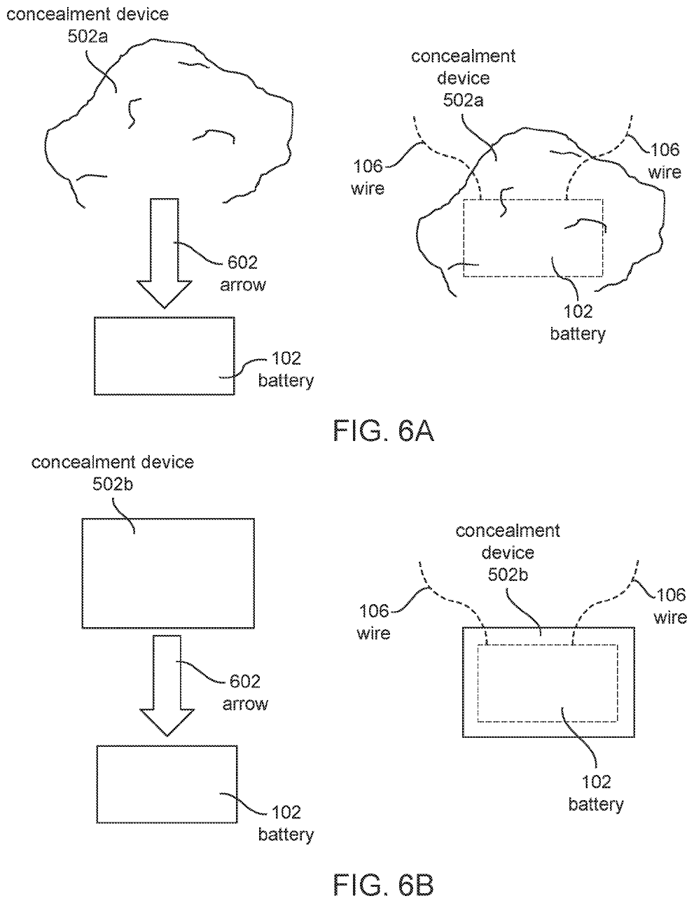

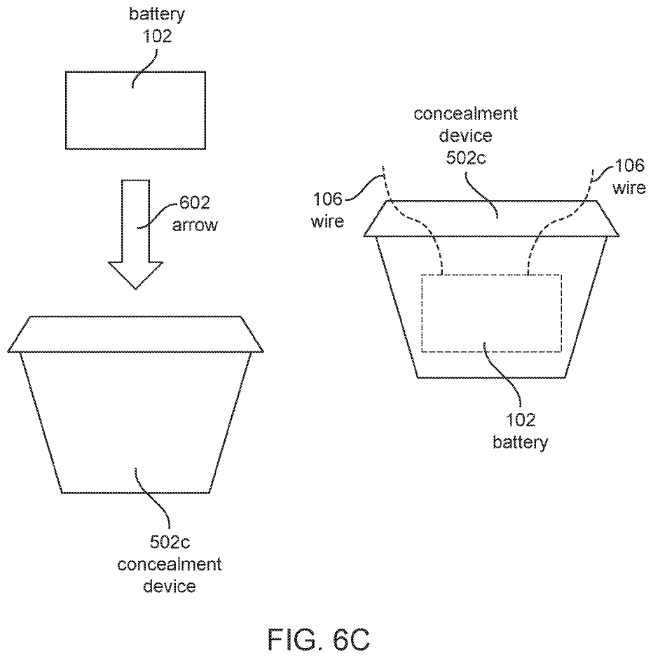

With either of the battery 102 housings 402 as shown in FIGS. 4A and 4B, the battery 102 may now be hidden underground. By hiding the battery 102 underground, the concealment devices of FIGS. 5, 6A, 6B, and 6C would not be needed, as the battery 102 is already hidden out of view, maintaining the aesthetics of the external premise 20. Additionally, by burying the battery 102, the battery 102 becomes more secure and facilitates the prevention of tampering with the energy source of the system.

The double-hulled exterior of the battery 102 housing 402 in both FIGS. 4A and 4B can facilitate prevention of chemical leakage of the battery 102 into the external premise 20, should such an issue occur. Also, this double-hulled exterior facilitates the avoidance of water or soil ingress into the battery.

FIG. 4B also illustrates a door 410. The door 410 may be used to retrieve the battery 102 from the housing 402 for replacement or recharging purposes. This would permit the housing 402 to be reusable, as well as recharging of the battery 102 without the need for an input wire 106b or solar panel 202. FIG. 4A does not show a door 410, but it is understood that this is for illustration purposes only, to show that the housing 402 may or may not include a door 410 in either the example of a vacuum 406 separating waterproof layers 404, or a di-electrical gel membrane 408 separating waterproof layers 404.

FIG. 5 illustrates a schematic view of an outdoor system including a concealment device 502. These concealment devices 502 may hide the battery 102 from view, so the external premise 20 still looks aesthetically pleasing. The concealment devices 502 of FIGS. 6A, 6B, and 6C are all present in FIG. 5, but it is understood that it is not necessary to include multiple batteries in the outdoor comfort-and-security system 30, though it is possible to do so if desired. Because of the variety of possible concealment devices 502, the size of the battery 102 may dictate what type of concealment device 502 is used. For instance, a rock-shaped concealment device 502a (FIG. 6A) in the external premise 20 would likely be used to conceal a larger battery 102 than a brick-shaped concealment device 502b (FIG. 6B), because a large, over-sized brick laying in the external premise 20 would look out of place. Hidden lines may again be seen connecting the remote battery 102 (hidden within concealment devices 50a and 502c) via an output wire to the at least one electronic devices 104.

FIGS. 6A, 6B, and 6C illustrate front views of possible concealment devices 502 for the battery 102. As can be seen in FIG. 6A, the concealment device 502a may be shaped like a rock. The rock-shaped concealment device 502a may be completely hollow, or at least partially hollow, in order to receive the battery 102. An arrow 602 indicates that the rock-shaped concealment device 502a may be lowered onto the battery 102, indicating that an opening may be present in the bottom of the rock-shaped concealment device 502a as a location where the battery 102 may be inserted. Also shown in FIG. 6A is the battery 102 as hidden lines as it may be located within the rock-shaped concealment device 502a.

FIG. 6B illustrates a concealment device 502b that is shaped like a brick. The brick-shaped concealment device 502b may be completely hollow, or at least partially hollow, in order to receive the battery 102. An arrow 602 indicates that the brick-shaped concealment device 502b may be lowered onto the battery 102, indicating that an opening may be present in the bottom of the brick-shaped concealment device 502b as a location where the battery 102 may be inserted. Also shown in FIG. 6B is the battery 102 as hidden lines as it may be located within the brick-shaped concealment device 502b.

FIG. 6C shows a concealment device 502c shaped like a planting pot. The planting pot-shaped concealment device 502c may be completely hollow, or at least partially hollow, in order to receive the battery 102. An arrow 602 indicates that the battery 102 may be lowered into the planting pot-shaped concealment device 502c, indicating that an opening may be present in the top of the planting pot-shaped concealment device 502c as a location where the battery 102 may be inserted. Also shown in FIG. 6C is the battery 102 as hidden lines as it may be located within the planting pot-shaped concealment device 502c.

As stated in the description of FIG. 5, the concealment device chosen is likely to reflect the size of the battery 102 desired, as well as the current aesthetics of the external premise 20 that the concealment device is intended to blend in with. While a rock-shaped concealment device, a brick-shaped concealment device, and a potting plant-shaped concealment device are shown in FIGS. 5, 6A, 6B, and 6C, it is understood that any large structure that is capable of being made hollow to permit a battery 102 within its interior could be converted into a concealment device.

In all of FIGS. 6A, 6B, and 6C, wires 106 are illustrated as coming from the battery 102 through the concealment devices 502a, 502b, and 502c. In some examples, the wire 106 may be a part of the concealment device 502. In other examples, the wire 106 may exit through the concealment device 502 through a small hole, to which sealant is applied to close any remaining gaps between the concealment device 502 and the wire 106. While each of FIGS. 6A, 6B, and 6C illustrate two wires 106 coming from the battery 102, it is understood that this number is for illustration purposes only, and as few as one wire 106 to as many wires 106 as the user desire may be included in the system 30. Additionally, the wire 106 is generalized in FIGS. 6A, 6B, and 6C, as it is understood that either an output wire 106a, an input wire 106b or both may be used in these examples.

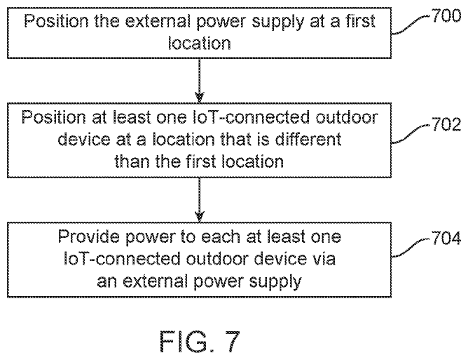

FIG. 7 illustrates a flowchart depicting a method of providing power to an outdoor device, according to some examples. In some examples, the method of providing power to an outdoor device includes positioning the external power supply at a first location (at step 700). According to some examples, the method of providing power to an outdoor device includes positioning at least one IoT-connected outdoor device at a location that is different than the first location (at step 702). The method of providing power to an outdoor device may include providing power to each at least one IoT-connected outdoor device via an external power supply (at step 704).

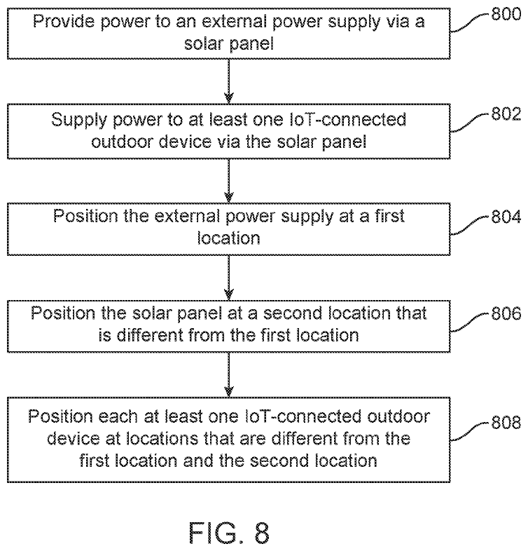

FIG. 8 illustrates a flowchart depicting a method of providing auxiliary power to a battery 102, according to some examples. In some examples, the method of providing auxiliary power to a battery 102 includes providing power to an external power supply via a solar panel 202 (at step 800). According to some examples, the method of providing auxiliary power to a battery 102 includes supplying power to at least one IoT-connected outdoor device via the solar panel 202 (at step 802). The method of providing auxiliary power to a battery 102 may include positioning the external power supply at a first location (at step 804). In some examples, the method of providing auxiliary power to a battery 102 includes positioning the solar panel 202 at a second location that is different from the first location (at step 806). According to some examples, the method of providing auxiliary power to a battery 102 includes positioning each at least one IoT-connected outdoor device at locations that are different from the first location and the second location (at step 808).

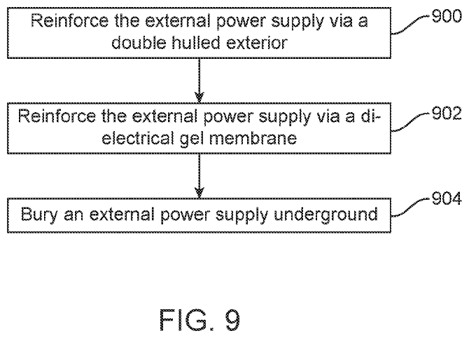

FIG. 9 illustrates a flowchart depicting a method of concealing a battery 102, according to some examples. In some examples, the method of concealing a battery 102 includes reinforcing the external power supply via a double-hulled exterior (at step 900). According to some examples, the method of concealing a battery 102 includes reinforcing the external power supply via a di-electrical gel membrane (at step 902). The method of concealing a battery 102 may include burying an external power supply underground (at step 904).

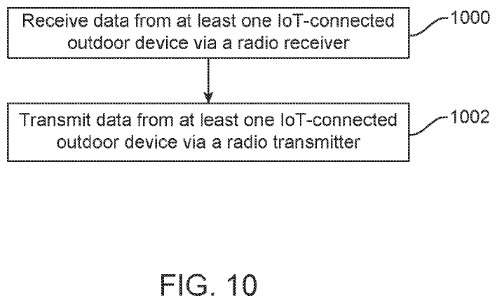

FIG. 10 illustrates a flowchart depicting a method of transmitting data from outdoor devices, according to some examples. In some examples, the method of transmitting data from outdoor devices includes receiving data from at least one IoT-connected outdoor device via a radio receiver (at step 1000). According to some examples, the method of transmitting data from outdoor devices includes transmitting data from at least one IoT-connected outdoor device via a radio transmitter (at step 1002). The data may be transmitted from or received by a wireless network, a local network, or a remote computing device operating on a cellular network.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,”“might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an. open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The foregoing may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

It is appreciated that in order to practice the method of the foregoing as described above, it is not necessary that the processors and/or the memories of the processing machine be physically located in the same geographical place. That is, each of the processors and the memory (or memories) used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, the processing performed by one distinct component as described above may be performed by two distinct components. In a similar manner, the memory storage performed by two distinct memory portions, as described above, may, in accordance with a further embodiment of the foregoing, be performed by a single memory portion. Further, the memory storage, performed by one distinct memory portion, as described above, may be performed by two memory portions.

Further, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the foregoing, a variety of “user interfaces” may be utilized to allow a user to interface with the processing machine or machines that are used to implement the foregoing. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the foregoing, it is not necessary that a human user actually interact with a user interface used by the processing machine of the foregoing. Rather, it is also contemplated that the user interface of the foregoing might interact, i.e., convey and receive information, with another processing machine, rather than a human user. Accordingly, the other processing machine might be characterized as a user. Further, it is contemplated that a user interface utilized in the system and method of the foregoing may interact partially with another processing machine or processing machines, while also interacting partially with a human user.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

We claim:

1. An outdoor comfort-and-security system comprising:
at least one electronic device configured to be positioned around an exterior premise of a building, each electronic device comprising communication circuitry configured to communicate data via a wireless network; and
a battery configured to be positioned exteriorly from the building,
wherein the battery is physically distinct from the at least one electronic device and electrically coupled to the at least one electronic device, and
wherein the battery comprises a minimum power output configured to power a respective primary function of the at least one electronic device and to enable the communication circuitry of the at least one electronic device to communicate the data via the wireless network.

2. The system of claim 1, further comprising a solar panel configured to be positioned exteriorly from the building, wherein the solar panel is electrically coupled to the battery to provide auxiliary power to the battery during a daylight time.

3. The system of claim 1, wherein the battery further comprises a housing comprising at least two nested waterproof layers.

4. The system of claim 3, wherein the housing further comprises a di-electrical gel membrane positioned between the at least two nested waterproof layers.

5. The system of claim 1, further comprising a concealment device defining a cavity configured to receive the battery.

6. The system of claim 5, wherein an exterior surface of the concealment device is configured to represent an object selected from the group consisting of a landscaping rock, a brick, a planting pot, and combinations thereof.

7. The system of claim 1, wherein the at least one electronic device comprises at least one security camera.

8. The system of claim 1, wherein the at least one electronic device comprises at least one motion detector.

9. The system of claim 1, wherein the at least one electronic device comprises at least one outdoor light.

10. The system of claim 1, wherein the communication circuitry of the at least one electronic device is configured to wirelessly communicate the data on a local network associated with the building.

11. The system of claim 1, wherein the communication circuitry of the at least one electronic device is configured to wirelessly communicate the data to a remote computing device via a cellular network.

12. A battery configured to power at least one electronic device of an outdoor comfort-and-security system of a building,
wherein the battery is configured to be positioned exteriorly from the building,
wherein the battery is physically distinct from the at least one electronic device and configured to removably and electrically couple to the at least one electronic device, and
wherein the battery comprises a minimum power output configured to power a respective primary function of the at least one electronic device and to enable communication circuitry of the at least one electronic device to communicate data via a wireless network.

13. The battery of claim 12, further comprising an electronic interface configured to electrically couple to a solar panel configured to be positioned exteriorly from the building and configured to provide auxiliary power to the battery during a daylight time.

14. The battery of claim 12, further comprising a housing comprising at least two nested waterproof layers.

15. The battery of claim 14, wherein the housing further comprises a di-electrical gel membrane positioned between the at least two nested waterproof layers.

16. The battery of claim 12, wherein an exterior surface of the battery is configured to represent an object selected from the group consisting of a landscaping rock, a brick, a planting pot, and combinations thereof.

17. A first electronic device for an outdoor comfort-and-security system, the first electronic device configured to be positioned at an exterior premise of a building, and comprising:
communication circuitry configured to communicate data via a wireless network, and
an electronic coupling comprising:
a first interface configured to removably and electrically couple the first electronic device to a battery configured to be positioned exteriorly from the building and having a minimum power output configured to power a primary function of the first electronic device and to enable the communication circuitry of the first electronic device to communicate the data via the wireless network; and
a second interface configured to electrically couple to the first interface and configured to removably and electrically couple to a second electronic device of the outdoor comfort-and-security system.

18. The first electronic device of claim 17, wherein the first electronic device is selected from the group consisting of a security camera, a motion detector, an outdoor light, and combinations thereof.

19. The first electronic device of claim 17, further comprising a battery configured to be positioned exteriorly from the building, wherein:
the battery is physically distinct from the first electronic device and the second electronic device, and
the battery comprises a minimum power output configured to power a respective primary function of at least one of the first electronic device and the second electronic device, and to enable the communication circuitry of at least one of the first electronic device and the second electronic device to communicate the data via the wireless network.

20. The first electronic device of claim 19, further comprising a solar panel configured to be positioned exteriorly from the building, wherein the solar panel is electrically coupled to the battery to provide auxiliary power to the battery during a daylight time.
